(19) United States
(12) Patent Application Publication
(10) Pub. No.: US 2009/0037229 A1
(43) Pub. Date: Feb. 5, 2009

(54) SYSTEM FOR MEASURING THE EXPOSURE TIME OF THE COVERAGE OFFERED BY AN INSURANCE POLICY

(76) Inventors: Jairo Alberto Perez Munoz, Bogota (CO); Rafael Hernan Polania Jimenez, Bogota (CO)

Correspondence Address: SMITH, GAMBRELL & RUSSELL, 1130 CONNECTICUT AVENUE, N.W., SUITE 1130, WASHINGTON, DC, 20036, US

(21) Appl. No.: 12/088,134

(22) PCT Filed: Sep. 27, 2005
(86) PCT No.: PCT/IB2005/002862

§ 371 Date: Sep. 4, 2008

(51) Int. Cl. G06Q 40/00; G07C 5/08

(52) U.S. Cl. 705/4

(57) ABSTRACT

The invention relates to a system which can be used to measure information corresponding to the term of insurance contracts in units of time of less than one day, using devices which are installed in the vehicles (or in other elements which require a mechanical or electrical motor or which are controlled by an electronic system), which are disposed at the insurance company's premises and which are in the possession of the policy holders.

### PURPOSE OF THE INVENTION

The present invention is directed to provide a system for measuring the information corresponding to the term of insurance contracts in units of time of less than one day by means of devices installed in the vehicles (or in other elements requiring a mechanical engine or electrical motor for the use thereof or whose operation is controlled by an electronic system), at the insurance company's premises and held by the policy holders.

The system also comprises the development of a process whereby it is possible to download from the Internet the information that allows recharging again the amount of available hours of insurance.

### BACKGROUND

To date Insurance Companies establish the term of their contracts using the day as the time measurement unit. Hence, when they issue an annual term policy, they refer to the expression “365 days”.

This practice implies a disadvantage for the policyholder of, for example, an automobile insurance policy. If such policyholder were to travel and be forced to leave his car parked at a parking lot for several days, the Insurance Company would still earn the premium for such amount of time despite not having assumed any risks relating to the insurance coverage associated to the movement of the vehicle, such as damages to third parties' property. Likewise, had the Insurance Company assumed the risk of earthquake, then it would be entitled to the premium for such coverage, even if the vehicle had not been in motion since such event would in fact create a risk thereto.

The above example lead us to consider that in order to strike a balance in the economic conditions of the insurance contract according to risk exposure, it is necessary to have an element that allows detailing the conditions of each one of the coverages offered.

Several documents are known in the State of the Art to disclose systems of calculating insurance premiums. For example Patent Application 20040039611 A1 refers to a method and system for reasonably calculating an automobile insurance premium using a smart card that has stored information relating to automobile wear, diagnostic and maintenance.

Patent Application 20050071202 A1 discloses a method and apparatus for determining an incremental cost of insurance for the operation of a motor vehicle and billing the same to an operator of the vehicle. The system uses an internal system for determining one or more operational factors associated with the vehicle such as geographic location, speed, acceleration, etc. and for recording said information in a database.

As it may be seen, even though there are in fact systems for calculating policy premiums according to the way in which the automobile is operated by the user, currently there are no systems capable of determining autonomously the portion usage of an insurance policy in units of time other than the day and which may be recharged depending on the usage the user makes of to his/her vehicle.

### DESCRIPTION OF THE INVENTION

The system subject matter of the present invention when applied to vehicle insurance, allows the distinction between the states “vehicle in use” and “vehicle not in use”, discounting the “time consumed” from the “total time” of the insurance, such that the policyholder can know how much “available time” of insurance there still is.

For the purposes of the present invention, applied to vehicle insurance, the concept “vehicle in use” relates to the state of a vehicle whose engine is working or running. The concept “vehicle not in use” corresponds to the state of a vehicle whose engine is turned off or shut off.

The concept “total time” corresponds to the number of hours initially acquired by the policy holder and is calculated as a function of the characteristics of the vehicle and other factors which according to each insurance company may be useful in determining the cost of such insurance. It corresponds as well to the sum of the concepts “available time” and “time consumed”.

The concept “available time” corresponds to the subtraction between the “total time” and the “consumed time”. In other words, “available time” refers to that period comprised between the time at which the observation of the system is carried out by a person and the exhaustion of the same, which circumstance automatically generates the ending of the corresponding insurance term.

The concept “time consumed” refers to that period of time elapsed between the beginning of the policy term and the time an observation is made by a person, and whose calculation is carried out as a function of vehicle “state”. Therefore, for example, depending on the nature of the coverages and therefore on the risk exposure of the Holder and/or Insurer, the “consumed time” will be greater when the vehicle is found in a “vehicle in use” state, than that relating to a “vehicle not in use” state.

The concept “time consumed” can be affected by attenuating or aggravating factors such as for example geographic location, brightness or climate. Hence, other types of sensors may also be incorporated to calculate the same.

An object of the present invention is providing a system that manages and controls the information corresponding to the “time consumed” and to the “available time” of the term of each policy by means that can be found at the premises of the Insurance Company or of third parties authorized thereby and in the insured vehicles.

The “total time” acquired for each protected vehicle is subtracted from the “total time” acquired by the Insurance Company. Each Insurer determines the “total time” for each insured vehicle and the corresponding cost, which amount is determined as a function of the characteristics of each vehicle and any other factors considered in its technical notes. The “total time” of each protected vehicle can be deducted from the “total time” of the Insurance Company, thus obtaining the “available time” of the Insurance Company.

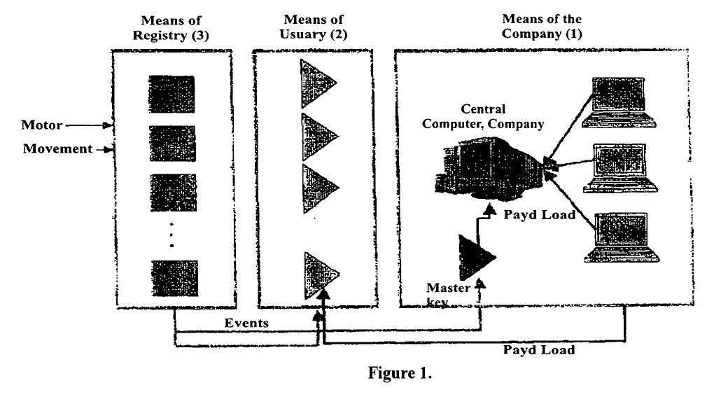

FIG. 1 shows the system object of the invention. In a general manner, the system comprises means for uploading and downloading information of the Insurance Company, user means for storing the downloaded information and consumption control means for controlling the available and consumed time of the acquired insurance.

The uploading and downloading means 1 corresponds to an interface for uploading the information from the Insurance Company corresponding to the available time of insurance calculated according to amount of a premium bought by the user with the policy. The user means 2 is inserted in said interface, and delivered to the Holder and/or Insured person and which carries the information relating to the “available time” of insurance for use by the Holder and/or Insured person.

Said user means 2 is mainly intended to upload and store the “available time” of insurance. When in the vehicle of the Holder and/or Insured person, its main purpose becomes that of transferring the previously uploaded information to the consumption control means 3 installed inside the insured vehicles.

Said consumption control means 3 is a user interface and is installed in the vehicle of such user, which is in charge of controlling and displaying both the “available time” of valid insurance and the “time consumed”. Hence, it is inside said consumption control means 3 that the discount calculation is made respecting the insured vehicle state (in or not in use), which is determined by means of a sensor 24. The devices comprising the means 3 are powered by the regulated voltage of the vehicle battery, further having backup batteries intended to guarantee proper operation of the system.

As a security feature of the system, only authorized personnel can gain access to the software by means of a password. On the other hand, the information stored in the user means 2 is encrypted and may only be decrypted by the Insurance Company software program and the control device of the consumption control means 3. The information stored in the user means 2 can be verified by the software for increased security. Once the “available time” of insurance has been transferred to the consumption control means 3 of the insured vehicle, the information is deleted by commands sent therefrom to the user means 2, remaining loaded only in the memory of the consumption control means 3, preventing thus the reutilization thereof.

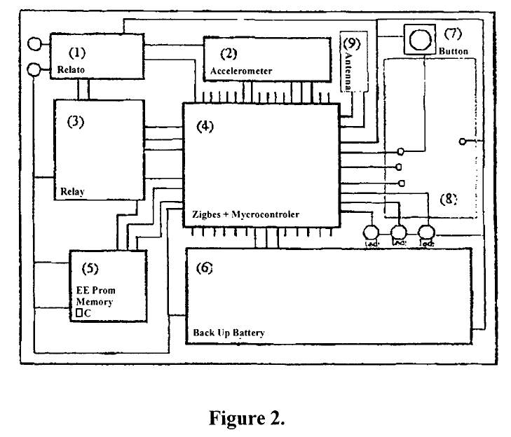

FIG. 2 details a preferred embodiment of the downloading means 1 of the insurance company. The insurance company's downloading means 1 comprise a plastic receptacle having at least two ports: one corresponding to a female USB terminal 4 for connecting to the Company's computer and the other being a four-pin male terminal for connecting to the user means 2. Inside there is a control unit 6 that manages bidirectional data transfer between the software and the user means 2, a USB interface device 8, four indicators (LEDs) 9 for determining the connection of the user means 2, the communication between the computer and the user means 2 and the data transfer in both directions, as well as a memory 7 for storing relevant data. The power supply of the downloading means of the insurance company 1 comes from the computer through the USB port 4.

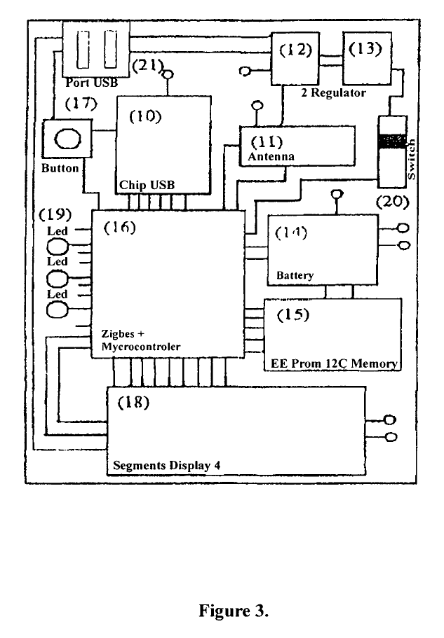

FIG. 3 details preferred user means 2 for use in the system of the minute invention. The user means 2 comprises a plastic receptacle having at least two connectors: a male USB connector 10, for further applications relating to data transfer via Internet, and the other a four-pin female connector 11 which is associated with a memory 13 found therein having a unique position and code for each user. Furthermore, it features a control device 12 that decrypts the information loaded by the insurance Company and an USB interface device 14. The power supply for this means comes from the means it connects to, through two pins in each connector. For uploading they relate to the USB port (Insurance Company's computer power supply) and for downloading they refer to the automobile device (vehicle battery). Furthermore, the user means 2 may include a display component for displaying relevant data such as the “available time”, even though it may also be possible to display any other type of information being relevant for the user and/or the insurance company.

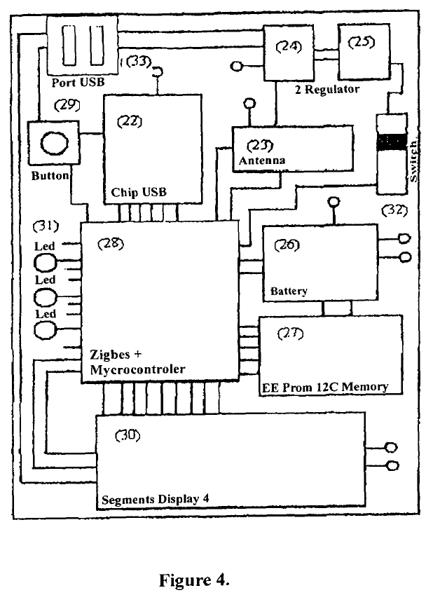

FIG. 4 teaches a preferred embodiment of the consumption control means 3 that is part of the system of the present invention. The consumption control means 3 that is associated in a non-detachable form to the insured article comprises a plastic receptacle containing a power supply element with a voltage regulator 19, a relay 18 determining use of either the main battery 16 or backup batteries 17 in case of a failure, a sensor 24 having its respective amplification element 23 for determining vehicle state, a memory 22 for storing the data coming from the user means 2, a control device 21 for processing input signals and a control of the discount display of the “time consumed” (not showed in this figure). Regarding the interface with the user means 2, there is an LCD 20 having three buttons 25, one for confirming data upload from user means 2, another for displaying information of “time consumed” by the vehicle and the third one for turning on the backup light of the LCD for displaying in the dark. Even though this preferred embodiment uses an LCD, any other mechanism capable of generating alphanumeric characters or audiovisual signals may be employed for purposes of displaying user information.

The consumption control means 3 further has three additional LED's 26 to indicate different events in its operation. The first one lights up if there is an error when connecting to the user means 2 and reading the same. The second one indicates proper operation of the vehicle state change detection sensor 24. Finally, the third one only lights up when the “available time” of insurance for the vehicle is running out and advises the user that the acquired policy is nearing expiration. Even though the LED's are the elements used in these preferred embodiments, other signaling mechanisms can be used also.

In addition to sensor 24, the consumption control means 3 may further comprise other sensors that measure both attenuating and aggravating factors in the consumption of the acquired policy, such as geographic location, brightness or climate. To this end, it is possible to incorporate other types of sensors allowing the calculation thereof.

It should be noted that the transfer of information between means 1, 2 and 3 may be performed via several mechanisms, one of which employs ports having one or more pins as shown in FIGS. 2, 3 and 4 (5); (11); (15), using an I2C protocol. This information transfer can also be undertaken by any other wired, wireless or optical means. Likewise the protocol used for conveying the information can be of a serial or parallel type or of any other type with which the purpose or goal of transferring information between the means conforming the system is achieved.

The purchase of additional “available time” for a policy can be performed by the insured person through an Internet web page, making the payment for said hours, in principle, with a credit card. The transfer of said hours to the user means 2 is carried out via the USB port of the computer the user is navigating the Internet with (See FIG. 1).

1. A system for measuring the exposure time of the coverages offered by an insurance company, characterized in that it comprises:
Uploading and downloading means (1) comprising a central computer, computers located at distributors and a device for transferring the information contained in the event recording means (3) to the computer at the company headquarters.
User means (2) provided with a USB or mini USB port, a push button, an LCD display, LED's, a non-volatile memory, a device for integrating a microcontroller with a wireless communication module, and a battery;
Event recording means (3) installed in the vehicle, and connected to the insured object only through its main power supply, being comprised of a power supply element having voltage regulation, a relay, acceleration sensors, non-volatile memory, a device for integrating activity control and signal processing with wireless communication, the modules and/or modems for said wireless communication and operation event indicator LED's.

2. A system according to claim 1, wherein the recording means (3) may comprise sensors for measuring attenuating and/or aggravating factors.

3. The system according to claim 1, characterized in that the information uploading and downloading means (1) allow uploading information relating to the insured object, the policyholder and the premium in time units.

4. The system according to claim 1, characterized in that the user means (2) processes the information collected in the event recording means (3) and determines the remaining coverage stated in time units.

5. The system according to claim 1, wherein the event recording means (3) allows the distinction between the static or dynamic conditions of the insured object and other consumption attenuating or aggravating factors.

6. The system according to claim 2, characterized in that the information uploading and downloading means (1) allow uploading information relating to the insured object, the policyholder and the premium in time units.

7. The system according to claim 2, characterized in that the user means (2) processes the information collected in the event recording means (3) and determines the remaining coverage stated in time units.

8. The system according to claim 3, characterized in that the user means (2) processes the information collected in the event recording means (3) and determines the remaining coverage stated in time units.

9. The system according to claim 6, characterized in that the user means (2) processes the information collected in the event recording means (3) and determines the remaining coverage stated in time units.

10. The system according to claim 2, wherein the event recording means (3) allows the distinction between the static or dynamic conditions of the insured object and other consumption attenuating or aggravating factors.

11. The system according to claim 3, wherein the event recording means (3) allows the distinction between the static or dynamic conditions of the insured object and other consumption attenuating or aggravating factors.

12. The system according to claim 6, wherein the event recording means (3) allows the distinction between the static or dynamic conditions of the insured object and other consumption attenuating or aggravating factors.
